(19) United States
(12) Patent Application Publication
(10) Pub. No.: US 2002/0033267 A1
(43) Pub. Date: Mar. 21, 2002

(54) Electrical hand-held power tool with a torque control

(76) Inventors: Edwin Schweizer, Balzers (CH); Roland Schaer, Grabs (CH)

Correspondence Address: DAVID TOREN, ESQ., SIDLEY, AUSTIN, BROWN & WOOD, LLP, 875 THIRD AVE, NEW YORK, NY, 10022, US

(21) Appl. No.: 09/952,159

(22) Filed: Sep. 14, 2001

(30) Foreign Application Priority Data
Sep. 16, 2000 (DE) 100 45 085.4

(51) Int. Cl. B25D 1/00

(52) U.S. Cl. 173/2

(57) ABSTRACT

An electrical hand-held power tool including an electrical drive (2) for transmitting a torque to a working tool (3) rotatable about an axis (a), a sensor (4) for determining an actual torque transmitted to the working tool (3), a control unit (5) for controlling operation of the electrical drive (2), a microcontroller (6) connected with the torque sensors (4) and the control unit (5), and a transceiver (7) for reading in identification data contained in identification data (9) associated with a fastening element (9) located in a corresponding transmission range, container for transporting fastening elements, and identification data carrier, and connected with the microcontroller; and a method of controlling the torque transmitted to the working tool (3).

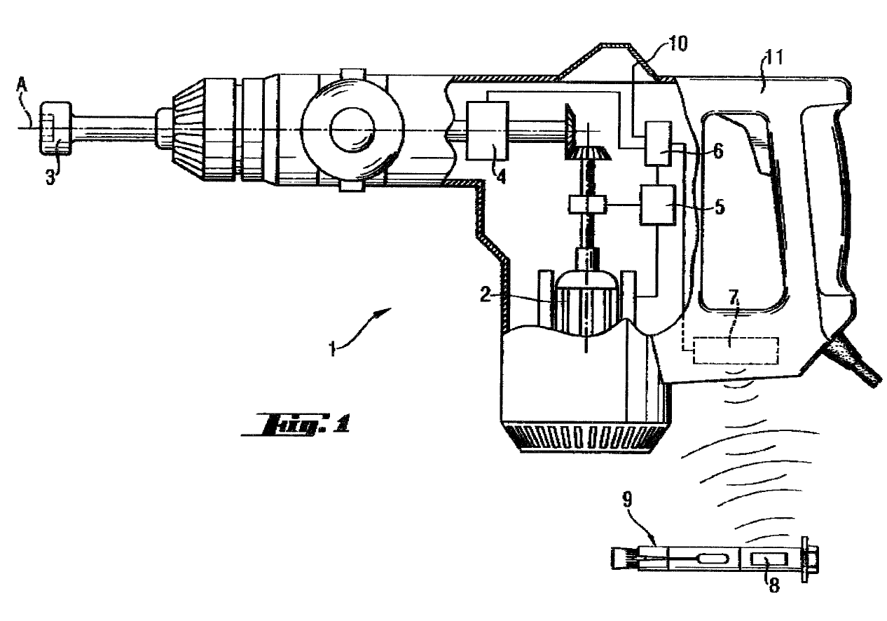

### BACKGROUND OF THE INVENTION

1. Field of the Invention

The present invention relates to an electrical hand-held power tool, such as a hand-held power screw driver, a hand-held power drill, or a hammer drill, for driving in fastening elements such as, e.g., anchors. The present invention also relates to method of controlling a torque of the electrical hand-held power tool, and to a fastening element to be set in or driven in with the electrical hand-held power tool.

2. Description of the Prior Art

Fastening elements, such as anchors, are primarily inserted in constructional materials to provide fixed points for a subsequent mounting of constructional and other elements with conventional connection means. In constructional industry, at present, anchors are tightened with a predetermined installation torque by a torque wrench or simply according to the feel or an operator. With a torque wrench, the tightening process is relatively time-consuming and is rather complicated. With the tightening according to the feel, the setting quality cannot be insured. In both cases, high demands are made to the operator.

U.S. Pat. Nos. 4,023,373 and 5,228,250 disclose anchors with mechanical means which prevents a predetermined optimal set torque room being exceeded.

In the industry, e.g., in the automotive industry, usually, a torque-controlled screw-in process in used. Japanese publication JP 60 31646 A2 discloses automatically stopping a hand-held power screw driver with a continuously controlled actual torque when a predetermined torque is reached. The screw driver is stopped by turning the drive off.

Japanese Publication JP 7 308864 A2 discloses an impact screw driver in which peak values of rotational impacts are objectively determined and, upon reaching an optimal attachment, frictionally engaged means of the drive, such as threaded connections, are stopped. However, such objective determination of an optimal attachment cannot be used with fastening elements which should have a strictly predetermined prestress.

U.S. Pat. No. 5,404,775 discloses an electrical angle screw driver in which the actual torque applied to workpiece is determined with a torque transducer formed of strain gages which determine a torque transmitted to a planetary gear which drives the working tool. The torque value is transmitted by a torque reading transmitter to a controller which automatically stops the drive when a predetermined torque is reached. The predetermined torque is inputted by input means, which again makes high demands to the operator.

International Publication WO86/03314 discloses the use of bar code labels for identification.

International Publication WO86/02186 discloses the use of film resonant circuit for identification.

International Publication WO89/05984 discloses the use of a fed from outside active transponder for identification, response to question, and storage of data and which can be mass-produced in a large number.

An object of the present invention is to provide an electrical hand-held tool which would insure an optimal attachment of a fastening element with a strictly predetermined presstress without intervention of the tool user to a most possible extent.

Another object of the present invention is to provide a method which would insure an optimal attachment of fastening element with a predetermined presstress.

A further object of the present invention is to provide a fastening element capable of being optimally attached with a predetermined presstress.

### SUMMARY OF THE INVENTION

These and other objects of the present invention, which will become apparent hereinafter, are achieved by providing an electrical hand-held power tool including an electrical drive for transmitting a torque to a working tool rotatable about an axis, a sensor for determining an actual torque transmitted to the working tool, a control unit for controlling operation of the electrical drive, and a microcontroller connected with the torque sensor and the control unit. The power tool further includes a transceiver for reading in identification data contained in identification means associated with at least one of fastening element located in a corresponding transmission range, container for transporting fastening elements, and identification means carrier. The transceiver is connected with the microcontroller for transmitting the identification data thereto.

According to the invention, there is provided, in the power tool, a transceiver, such as a scanner or a transponder, which reads the identification means which is secured on the fastening element, or on it transporting container, or is carried by an identification means carrier in form of a chip card and which transmits the readable-in data, and optimal predetermined torque, to the microcontroller. The microcontroller compares the predetermined torque with an actual torque determine by a torque sensor, and upon the actual torque valve reaching the predetermined torque valve, generates a signal transmitted to a drive control unit for automatically interrupting the setting process.

The wireless transmission of data from the identification means to the power tool insures an automatic, not dependent on a user, input of the predetermined torque which, together with the determination of actual torque, provides for an optimal attachment of a fastening element with a predetermined presstress.

According to a preferred embodiment of the present invention, the control unit is formed as an electronic motor control unit, which is arranged within the power supply circuit of the power tool motor and which is also connected, optionally, with an electronically controlled clutch and/or electronically controlled, mechanical or electrical brake.

Advantageously, the identification means comprises securable on or in the attachment element, in an unimportant location, a small bar code, a film resonant circuit, or a transponder containing, beside the predetermined torque, further data such as associated bore diameter, bore depth, length or type of the drill. All of the read-in data are displayed on a display provided on the housing and connected with the microcontroller.

The transceiver, dependent on the type of the identification means, is formed as a laser scanner/light receiver for a bar code, as a frequency-variable radio transceiver for a film resonant circuit, or as read or write/read unit for a transponder.

The inventive method includes reading-out, before or during rotation of the working tool about on axis, with the transceiver of the power tool, a predetermined torque identified by the identification means and transmitting read-in data to the microcontroller, and determining an actual torque transmitted to the working tool with the torque sensor and transmitting an actual torque value to the microcontroller. The microcontroller compares the actual torque value with the predetermined torque value, and communicates a signal to the control unit for turning the electrical drive off when the actual torque value becomes equal to the predetermine torque value.

The turning of the drive off is accompanied by interruption of the power transmission between the drive and the working tool or by braking the drive itself.

The novel features of the present invention, which are considered as characteristic for the invention, are set forth in the appended claims. The invention itself, however, both as to is construction and its mode of operation, together with additional advantages and objects thereof, will be best understood from the following detailed description of preferred embodiments, when read with reference to the accompanying drawings.

### BRIEF DESCRIPTION OF THE DRAWINGS

Single FIGURE of the drawings show a side, partially cross-sectional view of an electrical hand-held power tool according to the present invention.

### DETAILED DESCRIPTION OF THE PREFERRED EMBODIMENTS

An electrical hand-held power tool according to the present invention, which is shown in the drawings, includes an electrical drive 2 For driving a working tool 3 rotatable about an axis A. A sensor 4, which is provided in the transmission chain transmitting torque from an electromotor to the working tool 3, determines an actual torque transmitted to the working tool 3, The power tool 1 further includes a control unit 5 for controlling the operation of the electrical drive 2. The control unit 5 is formed as a motor control unit with a braking circuit. A microcontroller 6 connects the control unit 5 with a transceiver unit 7 which is formed as a frequency variable radio transceiver. The torque sensor 4 is also connected with the microcontroller 6. The transceiver 7 includes means for reading-in of type-specific identification data contained in identification means 8 which is formed as a film resonant circuit and is provided on a fastening element 9 that is formed as an anchor and is located in a corresponding transmission range. The microcontroller 6 is also connected with a display 10 provided on a power tool housing 11. The display 10 displays acquired identification data.

Though the present invention was shown and described with references to the preferred embodiments, such are merely illustrative of the present invention and are not to be construed as a limitation thereof, and various modifications of the present invention will be apparent to those skilled in the art. It is, therefore, not intended that the present invention be limited to the disclosed embodiments or details thereof, and the present invention includes all variations and/or alternative embodiments within the spirit and scope of the present invention as defined by the appended claims.

What is claimed is:

1. An electrical hand-held power tool, comprising an electrical drive (2) For transmitting a torque to a working tool (3) rotatable about an axis (A); a sensor (4) for determining an actual torque transmitted to the working tool (3), a control unit (5) for controlling operation of the drive (2); microcontroller (5) connected with the torque sensor (4) and the control unit (5) for actuating same; and a transceiver (7) for reading in identification data contained in identification means (8) associated with at least one of fastening element (9) located in a corresponding transmission range, container for transporting fastening elements, and identification means carrier, the transceiver (7) being connected with the microcontroller (6) for transmitting read-in identification data thereto.

2. An electrical hand-held power tool according to claim 1, further comprising a display (10) provided on a tool housing (11) and connected with the microcontroller (6) for displaying acquired data.

3. An electrical hand-hold power tool according to claim 1, wherein the control unit (5) is formed as an electronic motor control unit.

4. An electrical hand-held power tool, according to claim 3, wherein the control unit (5) is further associated with at least one of electronically controlled clutch and an electronically controlled brake.

5. An electrical hand-held power tool according to claim 1, wherein the transceiver (7) is formed as one of laser scanner/light receivers frequency-variable radio transceiver, read means, and write/read means, and wherein the identification means (8) is formed as one of readable bar code, film resonant circuit, and transponder.

6. A fastening element to be driven in with a predetermined torque by a hand-held power tool, comprising a body and identification means identifying the predetermined torque and associated with the fastening element, wherein the identification means is read by a power tool transceiver.

7. A fastening element according to claim 6, wherein the identification means is formed as one of bar code, film resonant circuit, and transponder.

8. A method of controlling a torque or an electrical hand-held power tool having an electrical drive (2) for transmitting a torque to a working tool (3) rotatable about an axis (A), a sensor (4) for determining an actual torque transmitted to the working tool (3), a control unit (5) for controlling operation of the electrical drive (2), a microcontroller (6) connected with the torque sensor (4) and the control unit (5) and a transceiver (7) for reading in identification data contained in identification means (8) associated with at least one of fastening element (9) located in a corresponding transmission range, container for transporting fastening elements, and identification means carrier, and connected with the microcontroller, the method comprising the steps of:
reading-out at least during one of before a start of rotation of working tool (3) about the axis (A) and rotation of the working tool (3) about the axis (A), with the transceiver (7) of the power tool, a predetermined torque identified by the identification means (8) and transmitting read-in data to the microcontroller,
determining an actual torque transmitted to the working tool (3) with the torque sensor (4) and transmitting an actual torque value to the microcontroller;
comparing the actual torque value with the predetermined torque value; and
turning the electrical drive (2) off when the actual torque value becomes equal to the predetermined torque value.

9. A method according to claim 8, wherein the turning-off step comprises at least one of interrupting power transmission between the drive (2) and the working tool (3) and braking the drive (2).
